(19) United States
(12) Patent Application Publication
(10) Pub. No.: US 2019/0311114 A1
(43) Pub. Date: Oct. 10, 2019

(54) MAN-MACHINE IDENTIFICATION METHOD AND DEVICE FOR CAPTCHA

(71) Applicant: ZhongAn Information Technology Service Co., Ltd., Shenzhen (CN)

(72) Inventors: Kun MEI, Shenzhen (CN); Xiao LU, Shenzhen (CN); Mingbo WANG, Shenzhen (CN); Yan TAN, Shenzhen (CN)

(21) Appl. No.: 16/392,311

(22) Filed: Apr. 23, 2019

Related U.S. Application Data
(63) Continuation of application No. PCT/CN2019/072354, filed on Jan. 18, 2019.

(30) Foreign Application Priority Data
Apr. 9, 2018 (CN) 201810309762.8

(51) Int. Cl. G06F 21/50; G06K 9/62; G06N 20/00

(52) U.S. Cl. CPC G06F 21/50; G06F 2221/2133; G06N 20/00; G06K 9/6257

(57) ABSTRACT

The present application discloses a man-machine identification method and device for a captcha. The method includes: collecting real-time user data when a first user inputs the captcha; and making a prediction for the real-time user data according to a machine learning model to determine an attribute of the first user. The machine learning model is obtained by training a sample data set, the sample data set includes one or more sets of training sample data and a label respectively set for each set of training sample data, and the label represents an attribute of a second user.

### CROSS-REFERENCE TO RELATED APPLICATIONS

The present application is a continuation of international application No. PCT/CN2019/072354 filed on Jan. 18, 2019, which claims priority to Chinese patent application No. 201810309762.8, filed on Apr. 9, 2018. Both applications are incorporated herein in their entireties by reference.

### TECHNICAL FIELD

The present disclosure mainly relates to the technical field of machine learning, and more particularly to a man-machine identification method and device for a captcha.

### BACKGROUND

Man-machine identification is a safety and automated public Turing machine test for identifying whether a registrant is a normal user or an abnormal user and distinguishing a computer from a human. The abnormal user, that is, a computer or a machine, can attack a website service by accessing a website continuously to request a login and simulating the normal user to input a captcha. Therefore, it becomes critical to defend a large website against an attack by identifying whether a login request is initiated by a normal user or an abnormal user.

CAPTCHA is an abbreviation for “Completely Automated Public Turing Test to tell Computers and Humans Apart”, which is a public fully automatic program that distinguishes whether a user is a computer or a normal user, and thereby automatically preventing a malicious user from using a specific program to make continuous login attempts to a website.

A current method for identifying whether a registrant is a normal user or an abnormal user is to monitor the normality of user access through a user browsing behavior model, which is established by using data obtained from a server log, for example, a Hidden Semi-Markov model (HsMM). This model is usually a statistical model with lower accuracy and slower recognition speed.

Therefore, a technical problem that needs to be urgently solved by those skilled in the art at present is how to establish an accurate and robust user identification model so as to accurately and quickly identify whether a user who logs in to verify is a normal user or an abnormal user.

### SUMMARY

In view of the above mentioned technical problem of lacking an accurate and robust model to identify whether a user is a normal user or an abnormal user, the present application provides a man-machine identification method by using a machine learning model. Machine learning is a kind of artificial intelligence, and its main purpose is to use previous experience or data to obtain certain rules from a large amount of data by means of an algorithm that enables a computer to “learn” automatically, so as to predict or reason about future data.

According to a first aspect of the embodiments of the present application, a man-machine identification method for a captcha is provided, which includes: collecting real-time user data when a first user inputs a captcha; and making a prediction for the real-time user data according to a machine learning model to determine an attribute of the first user. The machine learning model is obtained by training a sample data set, the sample data set includes one or more sets of training sample data and a label respectively set for each set of training sample data, and the label represents an attribute of a second user.

In some embodiments of the present application, the training sample data includes at least one of behavior data of the second user, risk data of the second user and terminal information data of the second user. The real-time user data includes at least one of behavior data of the first user, risk data of the first user and terminal information data of the first user.

In some embodiments of the present application, the captcha is a slider captcha. The behavior data of the second user includes mouse movement trajectory data of the second user before and after dragging the slider captcha. The risk data of the second user includes one or both of identity data and credit data of the second user. The terminal information data of the second user includes at least one of user agent data, a device fingerprint and an IP address. The behavior data of the first user includes mouse movement trajectory data of the first user before and after dragging the slider captcha. The risk data of the first user includes one or both of identity data and credit data of the first user. The terminal information data of the first user includes at least one of user agent data, a device fingerprint and an IP address.

In some embodiments of the present application, the attribute of the first user represents whether the first user is a normal user or an abnormal user.

In some embodiments of the present application, the method of the first aspect further includes: gathering the sample data set; and training the machine learning model by using the sample data set.

In some embodiments of the present application, the method of the first aspect further includes: adjusting the machine learning model by using the real-time user data as new training sample data.

In some embodiments of the present application, the training the machine learning model by using the sample data set includes: performing a feature engineering design on each of the one or more sets of training sample data to obtain one or more sets of sample features; and determining a parameter of the machine learning model by the one or more sets of sample features and the label corresponding to each set of training sample data respectively.

In some embodiments of the present application, the making a prediction for the real-time user data according to a machine learning model includes: performing a feature engineering design on the real-time user data to obtain a real-time user feature, and making the prediction for the real-time user feature by using the machine learning model.

In some embodiments of the present application, the machine learning model is an XGboost model.

According to a second aspect of the embodiments of the present application, a man-machine identification device for a captcha is provided, which includes: a collecting module configured to collect real-time user data when a first user inputs a captcha; and a predicting module configured to make a prediction for the real-time user data according to a machine learning model to determine an attribute of the first user. The machine learning model is obtained by training a sample data set, the sample data set includes one or more sets of training sample data and a label respectively set for each set of training sample data, and the label represents an attribute of a second user.

In some embodiments of the present application, the training sample data includes at least one of behavior data of the second user, risk data of the second user and terminal information data of the second user. The real-time user data includes at least one of behavior data of the first user, risk data of the first user and terminal information data of the first user.

In some embodiments of the present application, the captcha is a slider captcha. The behavior data of the second user includes mouse movement trajectory data of the second user before and after dragging the slider captcha. The risk data of the second user includes one or both of identity data and credit data of the second user. The terminal information data of the second user includes at least one of user agent data, a device fingerprint and an IP address. The behavior data of the first user includes mouse movement trajectory data of the first user before and after dragging the slider captcha. The risk data of the first user includes one or both of identity data and credit data of the first user. The terminal information data of the first user includes at least one of user agent data, a device fingerprint and an IP address.

In some embodiments of the present application, the attribute of the first user represents whether the first user is a normal user or an abnormal user.

In some embodiments of the present application, the device of the second aspect further includes: a gathering module configured to gather the sample data set; and a training module configured to train the machine learning model by using the sample data set.

In some embodiments of the present application, the device of the second aspect further includes an adjusting module configured to adjust the machine learning model by using the real-time user data as new training sample data.

In some embodiments of the present application, the training module is configured to perform a feature engineering design on each of the one or more sets of training sample data to obtain one or more sets of sample features, and determine a parameter of the machine learning model by the one or more sets of sample features and the label corresponding to each set of training sample data respectively.

In some embodiments of the present application, the predicting module is configured to perform a feature engineering design on the real-time user data to obtain a real-time user feature, and make the prediction for the real-time user feature by using the machine learning model.

In some embodiments of the present application, the machine learning model is an XGboost model.

According to a third aspect of the embodiments of the present application, a computer device is provided, which includes a processor and a storage device storing computer instructions that, when executed by the processor, cause the processor to perform a man-machine identification method for a captcha of the first aspect.

According to a fourth aspect of the embodiments of the present application, a computer-readable storage medium is provided, which stores computer instructions that, when executed by a processor, cause the processor to perform a man-machine identification method for a captcha of the first aspect.

In a man-machine identification method and device for a captcha provided by the embodiments of the present application, by using a machine learning model obtained by training to make a prediction for real-time user data in a process of verifying a captcha, it may be identified accurately whether a user is a normal user, thereby intercepting an abnormal user. Moreover, statistical models used conventionally can only handle a smaller amount of data and narrower data attributes, while in the embodiments of the present application, a larger amount of sample data can be handled when the machine learning model is trained, which increases the reliability and accuracy of a prediction compared to conventional methods.

### BRIEF DESCRIPTION OF DRAWINGS

In order to illustrate technical solutions of the embodiments of the present application more clearly, a brief introduction of the accompanying drawings used in descriptions of the embodiments will be given below.

FIG. 1 is a schematic flowchart illustrating a man-machine identification method for a captcha according to an embodiment of the present application.

FIG. 2 is a schematic flowchart illustrating a man-machine identification method for a captcha according to another embodiment of the present application.

FIG. 3 is a schematic flowchart illustrating a method for training a machine learning model according to an embodiment of the present application.

FIG. 4 is a schematic flowchart illustrating a method for making a prediction for real-time user data according to an embodiment of the present application.

FIG. 5 is a schematic structural diagram illustrating a man-machine identification device for a captcha according to an embodiment of the present application.

FIG. 6 is a block diagram illustrating a computer device for man-machine identification of a captcha according to an exemplary embodiment of the present application.

### DETAILED DESCRIPTION

A clear and complete description of technical solutions in the embodiments of the present application will be given below, in combination with the accompanying drawings in the embodiments of the present application. The embodiments described below are a part, but not all, of the embodiments of the present application. All of other embodiments, obtained by those skilled in the art based on the embodiments of the present application without creative efforts, shall fall within the protection scope of the present application.

Slider captcha is a kind of captcha that requires a user to drag a slider to a certain position in a process of verifying the captcha to achieve a verification effect. In the case where the captcha is a slider captcha, there is still no good solution for how to effectively establish an accurate and robust model to identify a normal user or an abnormal user in a process that the user drags the slider captcha.

The present application provides a man-machine identification method for a captcha, which can establish an accurate and robust user identification model in a process of verifying the captcha.

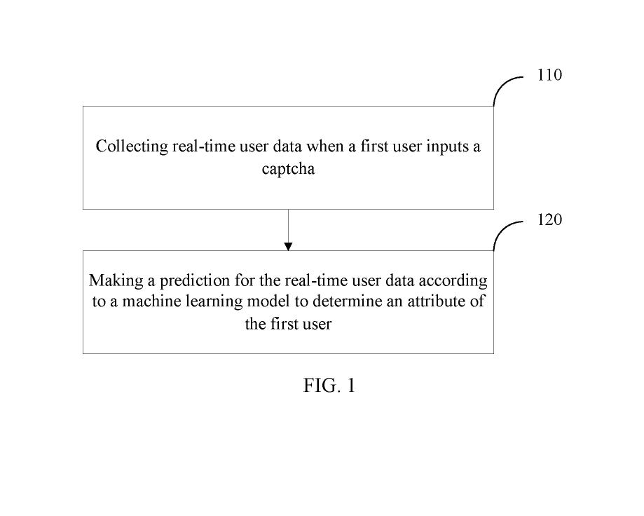

FIG. 1 is a schematic flowchart illustrating a man-machine identification method for a captcha according to an embodiment of the present application. As shown in FIG. 1, the method includes the following contents.

110: collecting real-time user data when a first user inputs a captcha.

120: making a prediction for the real-time user data according to a machine learning model to determine an attribute of the first user. The machine learning model is obtained by training a sample data set, the sample data set includes one or more sets of training sample data and a label respectively set for each set of training sample data, and the label represents an attribute of a second user.

Specifically, the first user may be a user who actually uses the machine learning model to identify the captcha input by the first user. The second user may be a user corresponding to the sample data set.

The label corresponding to each set of training sample data may be used for representing the attribute of the second user that generates the set of training sample data. Here, one or more sets of training sample data collected and the labels respectively corresponding to each set of training sample data are collectively referred to as a sample data set.

In a man-machine identification method for a captcha provided by the embodiments of the present application, by using a machine learning model obtained by training to make a prediction for real-time user data in a process of verifying a captcha, it may be identified accurately whether a user is a normal user, thereby intercepting an abnormal user. Moreover, statistical models used conventionally can only handle a smaller amount of data and narrower data attributes, while in the embodiments of the present application, a larger amount of sample data can be handled when the machine learning model is trained, which increases the reliability and accuracy of a prediction compared to conventional methods.

Further, the machine learning model used in the embodiments of the present application may run in parallel with the multi-thread of CPU, and thus the speed of the prediction can also be improved.

According to an embodiment of the present application, the attribute of the second user represents whether the second user is a normal user or an abnormal user.

Specifically, the normal user may represent that the operation object inputting the captcha is a person, and the abnormal user may represent that the operation object inputting the captcha is a machine such as a computer. In addition, the training sample data of the normal user may be taken as a negative sample with a label set to 0, while the sample data of the abnormal user may be taken as a positive sample with a label set to 1.

Corresponding to the attribute of the second user, the attribute of the first user may also represent whether the first user is a normal user or an abnormal user. In this way, when the captcha input by the first user is identified by using the machine learning model obtained by training the sample data set, the attribute of the first user may be determined, that is, it is determined whether the first user is a normal user or an abnormal user.

Of course, in other embodiments, the attribute of the first user/the attribute of the second user may represent other meanings set according to a prediction target.

According to an embodiment of the present application, the real-time user data includes at least one of behavior data of the first user, risk data of the first user and terminal information data of the first user. The training sample data includes at least one of behavior data of the second user, risk data of the second user and terminal information data of the second user.

Specifically, the behavior data of the first user may include a motion trajectory and/or a click behavior when the first user operates a mouse, and the like. The risk data of the first user may include one or both of identity information and credit data of the first user, and the like. The terminal information data of the first user may include at least one of User-agent data, a device fingerprint and a client IP address. The behavior data of the second user, the risk data of the second user and the terminal information data of the second user are similar to those of the first user, and in order to avoid repetition, details are not described redundantly herein.

In this embodiment, risk data and terminal information data of potential abnormal users may be obtained through a data provider or some shared information systems.

According to an embodiment of the present application, the captcha is a slider captcha. The behavior data of the first user includes mouse movement trajectory data of the first user before and after dragging the slider captcha. The behavior data of the second user includes mouse movement trajectory data of the second user before and after dragging the slider captcha.

Specifically, the mouse movement trajectory data includes abscissa, ordinate and time stamp for each movement of a mouse, and number of retrying.

Of course, in other embodiments, the captcha may also be other forms of captcha, such as a text or picture captcha. The training sample data may also be other data, such as risk data, for example, identity information and credit information of the second user.

According to an embodiment of the present application, the method further includes: gathering the sample data set; and training the machine learning model by using the sample data set.

Specifically, each set of training sample data refers to all relevant data obtained by a computer when a second user logs in. When building the machine learning model, mouse movement trajectory data of one or more groups of normal users and/or abnormal users before and after dragging the slider captcha and the terminal information data of the second user may be collected through a log server. A model builder may simulate one or both of a normal user and an abnormal user log in a website by dragging the slider captcha, and thus the mouse movement trajectory data can be obtained by the computer.

According to an embodiment of the present application, the training the machine learning model by using the sample data set includes: performing a feature engineering design on each of the one or more sets of training sample data to obtain one or more sets of sample features; and determining a parameter of the machine learning model by the one or more sets of sample features and the label corresponding to each set of training sample data respectively.

Specifically, data is the most important basis for machine learning, and the so-called feature engineering design refers to extracting features from collected raw data to the maximum extent, and obtaining a more comprehensive, more sufficient and multi-directional expression of the raw data for use by a model. The feature engineering may include data processing such as selecting a feature with high correlation according to a target, reducing or increasing dimension of data, and performing a numerical calculation on the raw data. Of course, in other embodiments, steps of the feature engineering design may also be omitted.

In an embodiment, as described above, the mouse movement trajectory data of one or more groups of normal users and/or abnormal users before and after dragging the slider captcha and the terminal information data of the second user are collected through a log server. According to the collected mouse movement trajectory data such as the abscissa, the ordinate and the time stamp for each movement of a mouse, and the number of retries, the following features are calculated and extracted: time elapsed by mouse movement, distance, maximum distance, average speed, maximum speed and speed variance of lateral movement, distance, maximum distance, average speed, maximum speed and speed variance of longitudinal movement, number of sliding attempts, and time interval before starting to slide. According to the collected terminal information data, the following features are calculated and extracted: user agent data, device fingerprint data, and IP address. Here, the user agent data may include browser-related attributes such as operating system and version, CPU type, browser and version, browser language, browser plug-in, and the like. The device fingerprint data may include feature information for identifying the device such as hardware ID of a device, IMEI of a mobile phone, Mac address of a network card, font setting, and the like. In this embodiment, the terminal information data is collected in addition to the behavior data of the second user, and thus the prediction accuracy of the machine learning model to a risk terminal is improved.

In this embodiment, characterized sample data is used, that is, one or more sets of sample features and the label (in an embodiment, the label is “0” or “1”) corresponding to each set of training sample data respectively are used to determine the parameter of the machine learning model.

According to an embodiment of the present application, the machine learning model used is a tree-based integrated learning model, eXtreme Gradient Boosting (XGboost). In this embodiment, for a given data set D={xᵢ,yᵢ)}, the XGboost model function is in the form of:

$${\hat{y}}_{i} = Φ ( {x}_{i} ) = {\sum }_{k = 1}^{K} {f}_{k} ( {x}_{i} ) , {f}_{k} ∈ F$$

In the above formula, K represents the number of trees to be learned, xᵢ is an input, and ŷᵢ represents a prediction result. F is an assumed space, and f(x) is a Classification and Regression Tree (CART):

F={f(x)=w_{q(x)}}(q:R^{m}→T,w∈R^{T})

Here, q(x) represents that a sample x is assigned to a leaf node, w is the fraction of the leaf node, and thus w_{q(x)} represents a predicted value of a regression tree for the sample. As can be seen from the above XGboost model function, the model performs an iterative calculation by using prediction results of each regression tree in K regression trees to obtain a final prediction result ŷᵢ. Moreover, input samples of each regression tree are related to the training and prediction of a previous regression tree.

In an embodiment, as described above, a feature engineering design is performed on the one or more sets of training sample data respectively to obtain one or more sets of sample features. Next, the one or more sets of sample features are taken as xᵢ in the data set D, and the label corresponding to each set of training sample data is taken as yᵢ in the data set D to learn a parameter of the K regression trees in the XGboost model. That is, the mapping relationship between the input xᵢ of each regression tree and the output ŷᵢ thereof is determined, and xᵢ may be an n-dimensional vector or array. That is, by inputting known training sample data xᵢ, comparing the prediction result ŷᵢ of the above model with the actual mapped label yᵢ of the training sample data, and adjusting a model parameter continuously until an expected accuracy is reached, the model parameter is determined, and thus a prediction model is established.

In other embodiments, other tree-based boost models in addition to the XGboost model may also be used, or other types of machine learning models, such as a random forest model, may also be used.

After the model has been established according to the training sample data and its corresponding labels, the generated model is saved.

After the machine learning model has been trained, the model may be used to make a prediction for a real-time user, that is, 110 and 120 may be performed. In 110, the behavior data of the first user is captured by data burying through a data collection code deployed to a login interface of a website. In an embodiment, the captcha is a slider captcha, and the mouse movement trajectory data of dragging the slider captcha and the terminal information data of the user are collected for each user who is performing a login operation. The type of these data is the same as that of the training sample data described above, and will not be described redundantly herein. Next, in 120, the trained machine learning model is used to make a prediction for the collected real-time user data to determine the attribute of the first user.

In an embodiment, 120 may include: performing a feature engineering design on the real-time user data; and making the prediction for the first user by using a previously trained machine learning model to determine the attribute of the first user.

Specifically, a method of feature engineering design and types of features obtained are similar to the method of feature engineering design and types of the training sample data described above, and will not be described redundantly herein. In an embodiment in which the machine learning model is an XGboost model, the attribute of the first user is determined by using the following model function:

$${\hat{y}}_{i} = Φ ( {x}_{i} ) = {\sum }_{k = 1}^{K} {f}_{k} ( {x}_{i} ) , {f}_{k} ∈ F$$

The parameter of the model function has been determined in the above steps, and therefore, by using the characterized real-time user data as the input xᵢ, the prediction result ŷᵢ for the input can be obtained. The input xᵢ may be an n-dimensional vector or array. In an embodiment, the prediction result ŷ is presented in the form of “0” or “1”. This is because when learning the parameter of the model, the label used is defined such that “0” represents a normal user and “1” represents an abnormal user. Of course, the result/label may be defined in other ways, as long as the normal user/abnormal user can be distinguished, or the result/label representing other attributes of a user may be defined. After the attribute of the first user is determined, the prediction result may be output.

If the prediction result is “1”, it represents that a user who is performing a login operation currently is an abnormal user, that is, a machine or a computer program logs in, and the user is prevented from logging in. If the prediction result is “0”, it represents that the user who is performing the login operation currently is a normal user, and the user is allowed to log in. Specifically, the prediction result may be fed back to a webpage front-end server, thereby realizing the interception of the abnormal user.

According to an embodiment of the present application, the method further includes adjusting the machine learning model by using the real-time user data as new training sample data.

Specifically, the real-time user data is fed back to the machine learning model as the new training sample data to train and update the model, the model parameter is further adjusted, thereby improving the prediction accuracy of the model. In an embodiment, the model is trained and updated at a period of T+1, wherein T represents a natural day. That is, the relevant data about the login of all users in each natural day (T) is used as the new training sample data to update and train the model on the second natural day (T+1) after the natural day to adjust the model parameter. In other embodiments, the model may also be trained and updated at a period of any time interval, for example, the model may be trained and updated in real time, hourly, and so on.

In a man-machine identification method for a captcha provided by the embodiments of the present application, an accurate and robust user identification model can be established in the process of verifying the captcha, thereby identifying the user type quickly and accurately. In an embodiment of using the XGboost machine learning model, 95% prediction accuracy may be achieved.

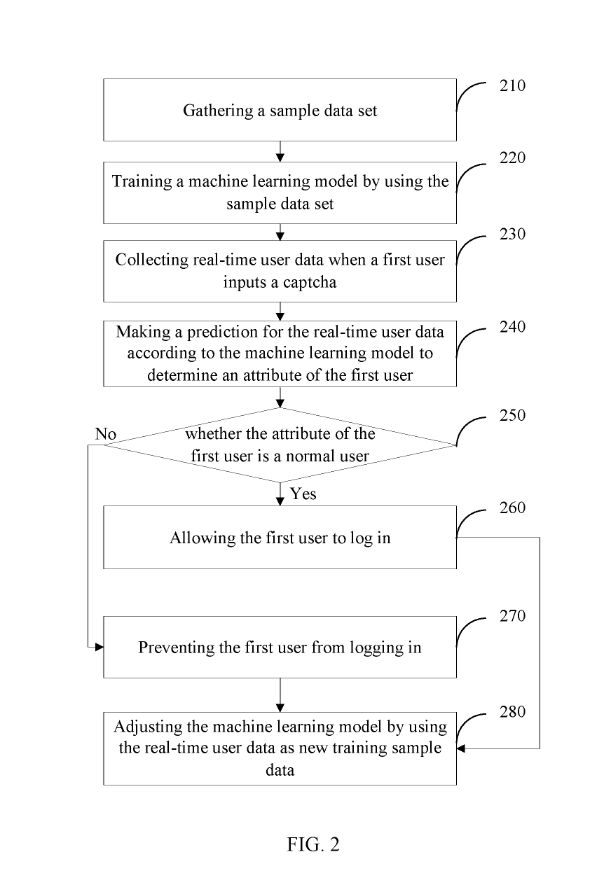

FIG. 2 is a schematic flowchart illustrating a man-machine identification method for a captcha according to another embodiment of the present application. As shown in FIG. 2, the method includes the following contents.

210: gathering a sample data set.

Specifically, the sample data set includes one or more sets of training sample data and a label respectively set for each set of training sample data. The label represents an attribute of a second user corresponding to the sample data set, that is, whether the second user is a normal user or an abnormal user.

220: training a machine learning model by using the sample data set.

230: collecting real-time user data when a first user inputs a captcha.

Specifically, for details about the real-time user data and the training sample data, please refer to the description in FIG. 1 above, which are not described redundantly herein.

240: making a prediction for the real-time user data according to the machine learning model to determine an attribute of the first user.

250: determining whether the attribute of the first user is a normal user, and if it is a normal user, 260 is executed, and if it is not a normal user, that is, it is an abnormal user, 270 is executed.

260: allowing the first user to log in.

270: preventing the first user from logging in.

280: adjusting the machine learning model by using the real-time user data as new training sample data.

Specifically, 280 may be executed after 240, or may be executed after 260 and 270, which is not limited by the present application.

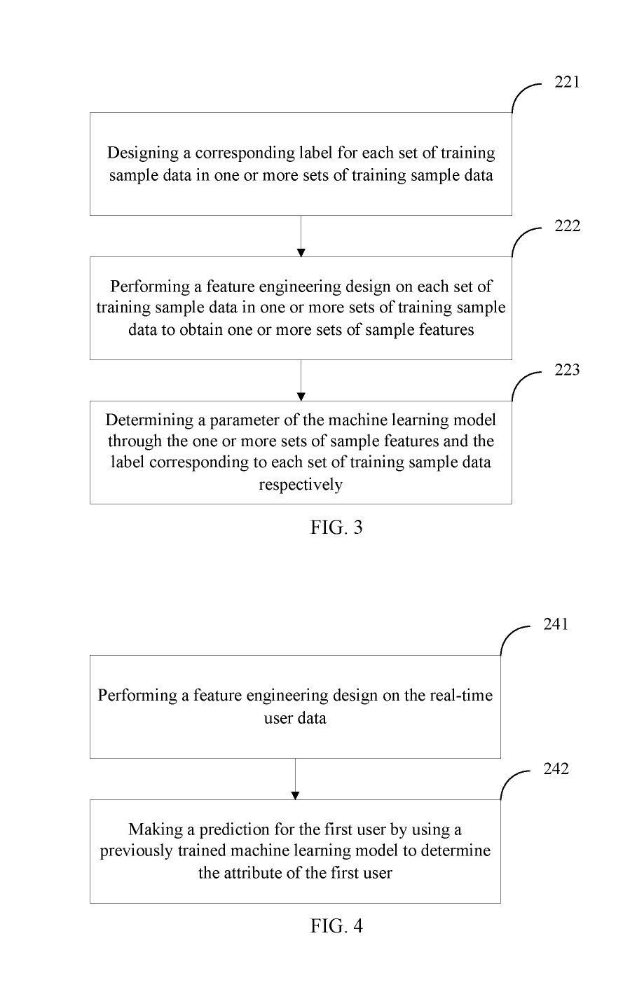

According to an embodiment of the present application, as shown in FIG. 3, 220 may further include the following contents.

221: designing corresponding a label for each set of training sample data in one or more sets of training sample data.

Specifically, the process of designing the label may be referred to the description in FIG. 1, which is not described redundantly herein.

In an embodiment, 221 may also be executed before 220.

222: performing a feature engineering design on each set of training sample data in one or more sets of training sample data to obtain one or more sets of sample features. Specifically, the process of obtaining the sample features may be referred to the description in FIG. 1, which is not described redundantly herein.

223: determining a parameter of the machine learning model through the one or more sets of sample features and the label corresponding to each set of training sample data respectively.

Specifically, the process of determining the parameters of the model may be referred to the description in FIG. 1, which is not described redundantly herein.

In this embodiment, 222 may be executed before 221, or may be executed after 221. After the machine learning model is established, the machine learning model is saved, and 230 and steps after 230 are executed.

According to an embodiment of the present application, as shown in FIG. 4, 240 may further include the following contents.

241: performing a feature engineering design on the real-time user data.

242: making a prediction for the first user by using a previously trained machine learning model to determine the attribute of the first user.

Specifically, a method of the feature engineering design and types of features obtained, and a process of determining the attribute of the first user may be referred to the description in FIG. 1, which is not described redundantly herein.

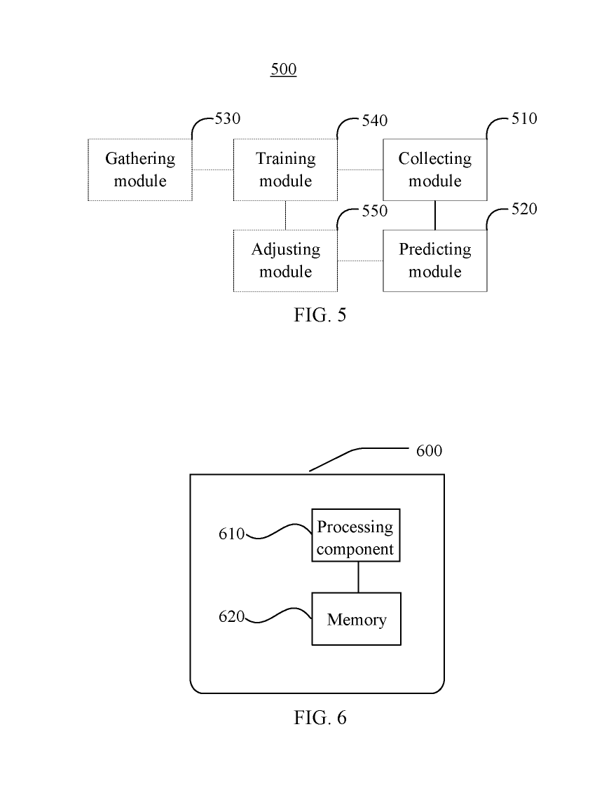

FIG. 5 is a schematic structural diagram illustrating a man-machine identification device 500 for a captcha according to an embodiment of the present application. As shown in FIG. 5, the device 500 includes: a collecting module 510 configured to collect real-time user data when a first user inputs a captcha; and a predicting module 520 configured to make a prediction for the real-time user data according to a machine learning model to determine an attribute of the first user. The machine learning model is obtained by training a sample data set. The sample data set includes one or more sets of training sample data and a label respectively set for each set of training sample data. The label represents an attribute of a second user.

In a man-machine identification device for a captcha provided by the embodiments of the present application, by using a machine learning model obtained by training to make a prediction for real-time user data in a process of verifying a captcha, it may be identified accurately whether a user is a normal user, thereby intercepting an abnormal user. Moreover, statistical models used conventionally can only handle a smaller amount of data and narrower data attributes, while in the embodiments of the present application, a larger amount of sample data can be handled when the machine learning model is trained, which increases the reliability and accuracy of a prediction compared to conventional methods.

According to an embodiment of the present application, the training sample data includes at least one of behavior data of the second user, risk data of the second user and terminal information data of the second user. The real-time user data includes at least one of behavior data of the first user, risk data of the first user and terminal information data of the first user.

According to an embodiment of the present application, the captcha is a slider captcha. The behavior data of the second user includes mouse movement trajectory data of the second user before and after dragging the slider captcha. The risk data of the second user includes one or both of identity data and credit data of the second user. The terminal information data of the second user includes at least one of user agent data, a device fingerprint and an IP address. The behavior data of the first user includes mouse movement trajectory data of the first user before and after dragging the slider captcha. The risk data of the first user includes one or both of identity data and credit data of the first user. The terminal information data of the first user includes at least one of user agent data, a device fingerprint and an IP address.

According to an embodiment of the present application, the attribute of the first user represents whether the first user is a normal user or an abnormal user.

According to an embodiment of the present application, the device 500 further includes: a gathering module 530 configured to gather the sample data set; and a training module 540 configured to train the machine learning model by using the sample data set.

According to an embodiment of the present application, the device 500 further includes an adjusting module 550 configured to adjust the machine learning model by using the real-time user data as new training sample data.

According to an embodiment of the present application, the training module 540 is configured to perform a feature engineer design on each of the one or more sets of training sample data to obtain one or more sets of sample features, and determine a parameter of the machine learning model by the one or more sets of sample features and the label corresponding to each set of training sample data respectively.

According to an embodiment of the present application, the predicting module 520 is configured to perform a feature engineering design on the real-time user data to obtain a real-time user feature, and make the prediction for the real-time user feature by using the machine learning model.

According to an embodiment of the present application, the machine learning model is an XGboost model.

FIG. 6 is a block diagram illustrating a computer device 600 for man-machine identification of a captcha according to an exemplary embodiment of the present application.

Referring to FIG. 6, the device 600 includes a processing component 610 that further includes one or more processors, and memory resources represented by a memory 620 for storing instructions executable by the processing component 610, such as an application program. The application program stored in the memory 620 may include one or more modules each corresponding to a set of instructions. Further, the processing component 610 is configured to execute the instructions to perform the above man-machine identification method for a captcha.

The device 600 may also include a power supply module configured to perform power management of the device 600, wired or wireless network interface(s) configured to connect the device 600 to a network, and an input/output (I/O) interface. The device 600 may operate based on an operating system stored in the memory 620, such as Windows Server™, Mac OS X™, Unix™, Linux™, FreeBSD™, or the like.

A non-temporary computer readable storage medium, when instructions in the storage medium are executed by a processor of the above device 600, cause the above device 600 to perform a man-machine identification method for a captcha, including: collecting real-time user data when a first user inputs a captcha; and making a prediction for the real-time user data according to a machine learning model to determine an attribute of the first user. The machine learning model is obtained by training a sample data set, and the sample data set includes one or more sets of training sample data and a label respectively set for each set of training sample data. The label represents an attribute of a second user.

Persons skilled in the art may realize that, units and algorithm steps of examples described in combination with the embodiments disclosed here can be implemented by electronic hardware, computer software, or the combination of the two. Whether the functions are executed by hardware or software depends on particular applications and design constraint conditions of the technical solutions. Persons skilled in the art may use different methods to implement the described functions for each particular application, but it should not be considered that the implementation goes beyond the scope of the present disclosure.

It can be clearly understood by persons skilled in the art that, for the purpose of convenient and brief description, for a detailed working process of the foregoing system, device and unit, reference may be made to the corresponding process in the method embodiments, and the details are not to be described here again.

In several embodiments provided in the present application, it should be understood that the disclosed system, device, and method may be implemented in other ways. For example, the described device embodiments are merely exemplary. For example, the unit division is merely logical functional division and may be other division in actual implementation. For example, multiple units or components may be combined or integrated into another system, or some features may be ignored or not performed. Furthermore, the shown or discussed coupling or direct coupling or communication connection may be accomplished through indirect coupling or communication connection between some interfaces, devices or units, or may be electrical, mechanical, or in other forms.

Units described as separate components may be or may not be physically separated. Components shown as units may be or may not be physical units, that is, may be integrated or may be distributed to a plurality of network units. Some or all of the units may be selected to achieve the objective of the solution of the embodiment according to actual demands.

In addition, the functional units in the embodiments of the present disclosure may either be integrated in a processing module, or each be a separate physical unit; alternatively, two or more of the units are integrated in one unit.

If implemented in the form of software functional units and sold or used as an independent product, the integrated units may also be stored in a computer readable storage medium. Based on such understanding, the technical solution of the present disclosure or the part that makes contributions to the prior art, or a part of the technical solution may be substantially embodied in the form of a software product. The computer software product is stored in a storage medium, and contains several instructions to instruct computer equipment (such as, a personal computer, a server, or network equipment) to perform all or a part of steps of the method described in the embodiments of the present disclosure. The storage medium includes various media capable of storing program codes, such as, a USB flash drive, a mobile hard disk, a Read-Only Memory (ROM), a Random Access Memory (RAM), a magnetic disk or an optical disk.

The above are only specific embodiments of the present application, but the protection scope of the present application are not limited thereto, and variations or alternatives that can be easily thought of by any person skilled in the art within the technical scope of the present application should be included within the protection scope of the present application. Therefore, the protection scope of the present application should be based on the protection scope of the claims.

What is claimed is:

1. A man-machine identification method for a captcha, comprising:
collecting real-time user data when a first user inputs a captcha; and
making a prediction for the real-time user data according to a machine learning model to determine an attribute of the first user, the machine learning model being obtained by training a sample data set, the sample data set comprising one or more sets of training sample data and a label respectively set for each set of training sample data, and the label representing an attribute of a second user.

2. The method according to claim 1, wherein the training sample data comprises at least one of behavior data of the second user, risk data of the second user and terminal information data of the second user, and the real-time user data comprises at least one of behavior data of the first user, risk data of the first user and terminal information data of the first user.

3. The method according to claim 2, wherein the captcha is a slider captcha, the behavior data of the second user comprises mouse movement trajectory data of the second user before and after dragging the slider captcha, the risk data of the second user comprises one or both of identity data and credit data of the second user, the terminal information data of the second user comprises at least one of user agent data, a device fingerprint and an IP address, the behavior data of the first user comprises mouse movement trajectory data of the first user before and after dragging the slider captcha, the risk data of the first user comprises one or both of identity data and credit data of the first user, and the terminal information data of the first user comprises at least one of user agent data, a device fingerprint and an IP address.

4. The method according to claim 1, wherein the attribute of the first user represents whether the first user is a normal user or an abnormal user.

5. The method according to claim 1, further comprising:
gathering the sample data set; and
training the machine learning model by using the sample data set.

6. The method according to claim 5, further comprising:
adjusting the machine learning model by using the real-time user data as new training sample data.

7. The method according to claim 5, wherein the training the machine learning model by using the sample data set comprises:
performing a feature engineering design on each of the one or more sets of training sample data to obtain one or more sets of sample features; and
determining a parameter of the machine learning model by the one or more sets of sample features and the label corresponding to each set of training sample data respectively.

8. The method according to claim 1, wherein the making a prediction for the real-time user data according to a machine learning model comprises:
performing a feature engineering design on the real-time user data to obtain a real-time user feature, and making the prediction for the real-time user feature by using the machine learning model.

9. The method according to claim 1, wherein the machine learning model is an XGboost model.

10. A man-machine identification device for a captcha, comprising:
a processor; and
a memory for storing instructions executable by the processor;
wherein the processor is configured to:
collect real-time user data when a first user inputs a captcha; and
make a prediction for the real-time user data according to a machine learning model to determine an attribute of the first user, the machine learning model being obtained by training a sample data set, the sample data set comprising one or more sets of training sample data and a label respectively set for each set of training sample data, and the label representing an attribute of a second user.

11. The device according to claim 10, wherein the training sample data comprises at least one of behavior data of the second user, risk data of the second user and terminal information data of the second user, and the real-time user data comprises at least one of behavior data of the first user, risk data of the first user and terminal information data of the first user.

12. The device according to claim 11, wherein the captcha is a slider captcha, the behavior data of the second user comprises mouse movement trajectory data of the second user before and after dragging the slider captcha, the risk data of the second user comprises one or both of identity data and credit data of the second user, the terminal information data of the second user comprises at least one of user agent data, a device fingerprint and an IP address, the behavior data of the first user comprises mouse movement trajectory data of the first user before and after dragging the slider captcha, the risk data of the first user comprises one or both of identity data and credit data of the first user, and the terminal information data of the first user comprises at least one of user agent data, a device fingerprint and an IP address.

13. The device according to claim 10, wherein the attribute of the first user represents whether the first user is a normal user or an abnormal user.

14. The device according to claim 10, wherein the processor is further configured to:
gather the sample data set; and
train the machine learning model by using the sample data set.

15. The device according to claim 14, wherein the processor is further configured to adjust the machine learning model by using the real-time user data as new training sample data.

16. The device according to claim 14, wherein the processor is configured to perform a feature engineering design on each of the one or more sets of training sample data to obtain one or more sets of sample features, and determine a parameter of the machine learning model by the one or more sets of sample features and the label corresponding to each set of training sample data respectively.

17. The device according to claim 10, wherein the processor is configured to perform a feature engineering design on the real-time user data to obtain a real-time user feature, and make the prediction for the real-time user feature by using the machine learning model.

18. The device according to claim 10, wherein the machine learning model is an XGboost model.

19. A computer-readable storage medium storing computer instructions that, when executed by a processor, cause the processor to perform:
collecting real-time user data when a first user inputs a captcha; and
making a prediction for the real-time user data according to a machine learning model to determine an attribute of the first user, the machine learning model being obtained by training a sample data set, the sample data set comprising one or more sets of training sample data and a label respectively set for each set of training sample data, and the label representing an attribute of a second user.

20. The computer-readable storage medium according to claim 19, wherein the processor is further configured to:
gather the sample data set; and
train the machine learning model by using the sample data set.
